(19) United States
(12) Patent Application Publication
(10) Pub. No.: US 2023/0080716 A1
(43) Pub. Date: Mar. 16, 2023

(54) METHOD AND CONTROL UNIT FOR AUTOMATED APPLICATION OF DRIVER ASSISTANCE SYSTEMS IN SERIAL OPERATION

(71) Applicant: Dr. Ing. h.c. F. Porsche Aktiengesellschaft, Stuttgart (DE)

(72) Inventor: Moritz Markofsky, Renningen (DE)

(21) Appl. No.: 17/883,253

(22) Filed: Aug. 8, 2022

(30) Foreign Application Priority Data
Sep. 13, 2021 (DE) 10 2021 123 597.9

(51) Int. Cl. B60W 60/00; B60W 40/09

(52) U.S. Cl. CPC B60W 60/001; B60W 40/09; B60W 2540/30

(57) ABSTRACT

A method is provided for automated application (10) of a driver assistance system that is configured to implement automated driving functions. At least one application parameter is assigned to each automated driving function (12). Factory settings preset both the application parameter and acceptable ranges for the application parameters that are consistent with safety-critical requirements. A control unit identifies a relevant driving scenario after an automated driving function (12) has been implemented during normal driving operation (13, 14). The control unit uses an objective grading model to evaluate (17) a performance of each implemented automated driving function while continuing execution during a normal driving operation (13, 14). The at least one respectively assigned application parameter is adapted (15), as a result of an optimization (11), on the basis of the evaluation (17) of the performance of the respectively implemented automated driving function (12).

### CROSS REFERENCE TO RELATED APPLICATION

This application claims priority on German Patent Application No 10 2021 123 597.9 filed Sep. 13, 2021, the entire disclosure of which is incorporated herein by reference.

### BACKGROUND

### Field of the Invention

A method is provided for automated application of a driver assistance system during serial operation, i.e., during normal vehicle participation in road traffic. A control unit and a computer program product also are provided to carry out the method.

### Related Art

A simulation environment for virtual application is used to apply driver assistance systems, abbreviated as DAS, or highly automated driving, abbreviated as HAD, virtually, i.e., without hardware or hardware prototype. The term “application” in this respect is understood to mean adapting free parameters of a driving function to the vehicle to adjust a desired driving behavior or a desired response behavior of the respective driving function. Such applications usually are performed by application engineers during test runs.

DE 10 2019 134 053 A1 discloses a method for applying a driver assistance system where a parameter set of the driver assistance system is adapted iteratively by repeatedly and alternately simulating a road test and carrying out a real road test.

US 2016/0221575 A1 describes a method for applying a driver assistance system, in which, during a driving operation, environmental data and data about the perceptions of vehicle occupants are captured. An evaluation of the driver assistance system is implemented based on the environmental data and the perception data. The results of the evaluation then are used in the development of the driver assistance system through use in driving simulations.

US 2017/0369052 A1 discloses a method for operating a driver assistance system with personalized driving profiles. A driving style of the driver is determined during manual driving operations, and application parameters of the driver assistance system are adapted based on the determined driving style of the driver.

The application in virtual simulation environments already is possible in an early development phase without hardware prototypes and can be implemented with the aid of mathematical optimization methods, especially in the case of mutually influencing application parameters, as far as possible for a variety of driving situations, in particular safety-critical driving situations. An optimal application can only be as good as accuracy of the virtual simulation environment allows. Some situations for which an application of the DAS/HAD is necessary also only arise in real traffic situations, independently of simulated or real test environments.

In light of this, an object of invention is to provide a method and system for the application of driver assistance systems that increases the accuracy of the application. Aspects of the method and system also should take into account individually preferred driving behavior for a driver in the application.

### SUMMARY

A method is provided for automated application of a driver assistance system. The driver assistance system is configured to implement automated driving functions, and at least one application parameter is assigned to each automated driving function. Each application parameter is preset by a factory setting and the respective application parameters can be changed within a respective parameter range that is defined according to safety-critical requirements. A performance of the implementation of the respective automated driving function is evaluated by an objective grading model during continued execution. More particularly, a control unit identifies a relevant driving scenario, and the control unit then implements a respective automated driving function based on this identification of the relevant driving scenario. The control unit then carries out the evaluation during normal driving operation after implementation of the respective automated driving function upon. The at least one respectively assigned application parameter is adapted, as a result of an optimization, on the basis of the evaluation of the performance of the respectively implemented automated driving function.

The above references to normal driving operation or serial operation mean that the driver assistance system is not in a simulation environment but is arranged in a real vehicle. The vehicle moves in a real environment and participates in road traffic. The vehicle is used by a (real) driver. The driver may be a buyer or an owner of the vehicle, i.e., the vehicle may be in everyday use by its buyer. Thus, the driver leaves selected driving scenarios, such as a lane change, to the driver assistance system or to automated driving. The method according to the invention advantageously automates the application of the driver assistance system under real driving conditions in a real environment.

The factory-defined restriction of the adaptation of the application parameters to the respective parameter range ensures that the automated application according to the invention is allowed only a certain amount of latitude for the respective application parameters. The latitude is selected so as not to compromise the safety of the driving operation during implementation of the respective automated driving function.

A relevant driving scenario is given, for example, by execution of an automated driving function from the following list: lane changes, passing maneuver, maintaining distance to vehicle ahead, and parking maneuver. Predetermined conditions must exist for a driving scenario to be identified as relevant so that the application of the respective automated driving function is then generally useful based on the identified driving scenario. For example, the respective automated driving function must have been implemented in a manner undisturbed by road users intervening during the implementation, which is the case, for example, if sensor data of a radar do not report an additional vehicle that appears.

The objective grading model evaluates the respective automated driving function based on sensor data and evaluation tables that may be stored in a memory of the control unit or in a cloud service that can be accessed. An evaluation table that links the sensor data to predetermined objective evaluations is assigned to the respective automated driving function. For example, a “jerk” in driving behavior can be used as a measure for the evaluation of the driving comfort perceived by vehicle occupants. If the sensor data include such a jerk of the vehicle during an automated driving function, the evaluation table passes a task to the optimization to minimize the jerk by parameterizing this automated driving function. A further example is the automated driving function “Maintain distance to vehicle ahead.” Here, a distance value serves, for example, as a measure of a subjective feeling of safety. If the objective grading model determined that the driver places particular emphasis on safety in their basic settings of the vehicle, then the objective grading model assigns a greater distance in the evaluation than the factory distance (which satisfies safety-critical values). In continuation of the further example, the driver has canceled the automated driving function “Maintain distance to vehicle ahead” by actuating the brake pedal to increase the distance to the vehicle ahead. The objective grading model concludes therefrom that confidence in this driving function was not sufficient. Thus, optimization is initiated to adapt the at least one respectively assigned application parameter to maintain a greater distance during the automated driving function “Maintain distance to vehicle ahead.” Accordingly, other driver interventions in the automated driving functions may also result in optimization of the respective application parameters.

In one embodiment, the respective automated driving function is evaluated based on driver evaluations in addition to the evaluation by the objective grading model. For example, after completion of the automated driving function “Maintain distance to vehicle ahead,” the driver is asked, via an automated voice prompt, whether the maintained distance in the previous automated driving function should be increased or decreased. Within safety-critical parameter ranges, a requirement for the respective application parameters then is transmitted to the optimization. The method according to the invention thus advantageously makes it possible to also include a driving style of the driver and/or their subjective opinion in the optimization.

It is also conceivable to allow this automatic adaptation to a driver's wishes only in a certain mode of the driving function. For example, the driver can choose between the “Comfort,” “Sports” and “Individual” modes. In the “Individual” mode, the driver regularly evaluates the performance of the respective automated driving function with automated voice prompts for questions such as “How safe did you feel?” or “Could the function act more like a sports car?” and thus provides subjective input parameters for the optimization.

In one embodiment of the method, the respective evaluation is evaluated internally in the vehicle.

In a further embodiment of the method, the respective evaluation is evaluated via a cloud service, and a result is transmitted to the driver assistance system. The respective result is transmitted by the cloud service to a manufacturer of the driver assistance system.

In a yet further embodiment of the method, a lower limit and the respective upper limit for settings of the respective application parameters are newly determined by the manufacturer from a plurality of transmitted results.

In a further embodiment of the method, all application parameters are reset to the factory setting by the driver.

This disclosure also relates to a control unit for automated application of a driver assistance system. The control unit comprises a computing unit and a memory unit. A “computing unit” may be understood in connection with the invention to mean a machine or electronic circuitry or a high-performance computer, for example. In particular, a computing unit may be a master processor (central processing unit (CPU)), a microprocessor, or a microcontroller, for example an application-specific integrated circuit or a digital signal processor, optionally in combination with the memory unit for storing program instructions, etc. A processor may also be understood to mean a virtualized processor, a virtual machine, or a soft CPU. For example, it may also be a programmable processor equipped with configuration steps for carrying out the above-mentioned method according to the invention or configured with configuration steps in such a way that the programmable processor realizes the features according to the invention of the method, the component, the modules, or other aspects and/or partial aspects of the invention. In addition, highly parallel computing units and high-performance graphics modules may be provided. The “memory unit” also may be referred to as a “memory module” and the like, and may, for example, be understood in connection with the invention to mean a non-volatile memory in the form of a flash memory (Flash EEPROM) or a permanent memory, such as a hard drive. A “module” may, for example, be understood in connection with the invention to mean a processor and/or a memory unit for storing program instructions. For example, the processor is specifically configured to execute the program instructions in such a way that the processor executes functions in order to implement or realize the method according to the invention or a step of the method according to the invention.

The control unit is in communicative connection, e.g., via a CAN bus, with the driver assistance system and with sensors and actuators controlled by the driver assistance system. The sensors may include optical sensors, radar sensors and/or various position sensors (e.g. LIDAR) that can determine the position and alignment of the vehicle relative to other vehicles, roadway or lane markings, traffic control devices and objects on or near the road. The sensors also can communicate with various vehicle operating systems such as speed sensors, acceleration sensors, deceleration sensors, traction sensors, tire pressure sensors, temperature sensors and rain sensors to name a few. The actuators may include acceleration actuators (e.g. accelerator pedals) braking actuators and steering actuators. The driver assistance system is configured to implement automated driving functions. At least one application parameter is assigned to each automated driving function. Each application parameter is preset by a factory setting and a parameter range that is defined according to safety-critical requirements. Each application parameters can be changed within the respective parameter range. The control unit is configured, in continued execution during normal driving operation upon implementation of the respective automated driving function by the driver assistance system, to store all data from the sensors and actuators controlled by the driver assistance system and, after implementation of the respective automated driving function upon identification of a relevant driving scenario, to evaluate a performance of the implementation of the respective automated driving function by means of an objective grading model, and to adapt, as a result of an optimization, the at least one assigned application parameter on the basis of the evaluation of the performance of the respectively implemented automated driving function.

In one embodiment the control unit additionally is configured to evaluate the respective automated driving function based on driver evaluations in addition to the evaluation by the objective grading model.

The disclosure also relates to a computer program product with a computer-readable medium. An executable program code for automated application of a driver assistance system configured to implement automated driving functions is stored on the computer-readable medium. When executed on the computing unit, the program code causes the computing unit to carry out, in continued execution, the following steps:
Storing all data of a plurality of sensors and actuators controlled by the driver assistance system relating respectively to automated driving functions implemented by the driver assistance system;
Identifying a relevant driving scenario;
Evaluating the performance of the respectively implemented automated driving function;
Optimizing at least one application parameter assigned to the respectively implemented automated driving function;
Adapting the at least one respectively assigned application parameter.

The disclosure also relates to a driver assistance system that comprises a control unit according to the invention and a computer program product according to the invention. The driver assistance system is configured to carry out the method of the invention.

The driver assistance system according to the invention is thus advantageously further developed in everyday road traffic and adapted to the driver's preferences. Since such optimization takes place in a real field of application of the driver assistance system, no simulation-related simplifications or simulation inaccuracies exist. By the driver being able to (subjectively) improve the driver assistance system themselves, a further incentive for the driver to use the method according to the invention is advantageously created.

Additional advantages and embodiments of the invention result from the description and the enclosed drawing.

It goes without saying that the features mentioned above can be used not only in the respectively specified combination but also in other combinations or alone, without leaving the scope of the present invention.

### BRIEF DESCRIPTION OF THE DRAWINGS

FIG. 1 shows a flow chart for the automated application of a driver assistance system in an embodiment of the method according to the invention.

### DETAILED DESCRIPTION

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software-based components.

It will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

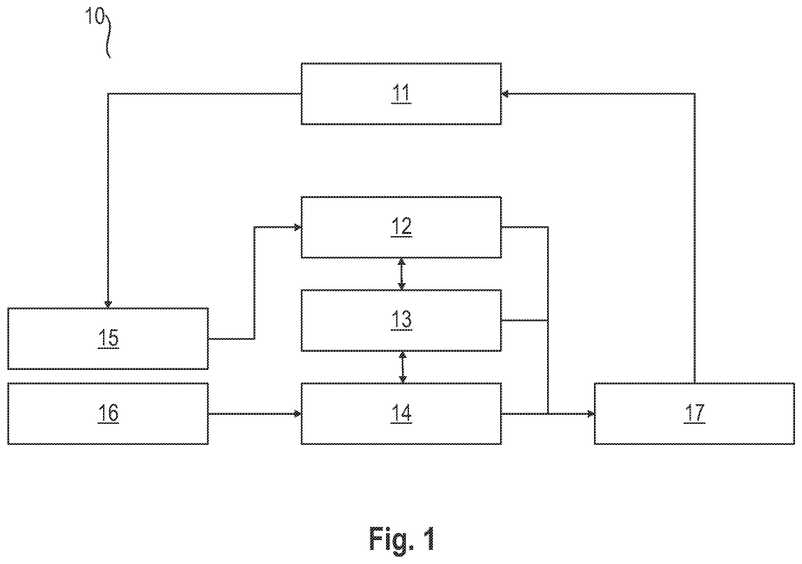

FIG. 1 shows a flow chart 10 for the automated application of a driver assistance system in an embodiment of the method according to the invention. In real road traffic or a real environment 14, an evaluation 17 of a performance of the implementation according to an objective grading model is evaluated for a vehicle with a driver 13 after identification 16 of a relevant driving scenario and after implementation of a respective automated driving function 12 by a driver assistance system. The resulting requirements for respective application parameters assigned to the respective automated driving function are provided to an optimization 11, the result of which leads to an adaptation 15 of the respective application parameters.

It is to be appreciated that the evaluation 17, the optimization 11 and the adaptation 15 may be carried out by the above described control unit that includes at least one computing unit and at least one memory unit. The functions of the control unit may be provided through the use of dedicated hardware as well as hardware capable of executing software in association with appropriate software. In one embodiment, some or all of the functions may be performed by at least one processor, such as a computer or an electronic data processor, digital signal processor or embedded micro-controller, in accordance with code, such as computer program code, software, and/or integrated circuits that are coded to perform such functions, unless indicated otherwise. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage. Other hardware, conventional and/or custom, may also be included in the control unit, such as a memory, input/output interfaces, a wireless transceiver, analog-to-digital converters, etc.

It is to be appreciated that the various features shown and described are interchangeable, that is a feature shown in one embodiment may be incorporated into another embodiment. It is further to be appreciated that the methods, functions, algorithms, etc. described above may be implemented by any single device and/or combinations of devices forming a system, including but not limited to storage devices, processors, memories, FPGAs, DSPs, etc.

While non-limiting embodiments are disclosed herein, many variations are possible which remain within the concept and scope of the present disclosure. Such variations would become clear to one of ordinary skill in the art after inspection of the specification, drawings and claims herein. The present disclosure therefore is not to be restricted except within the spirit and scope of the appended claims.

Furthermore, although the foregoing text sets forth a detailed description of numerous embodiments, it should be understood that the legal scope of the present disclosure is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

### LIST OF REFERENCE SYMBOLS

10 Flow chart for automation of driver assistance system
11 Optimization
12 Automated driving function
13 Real vehicle and driver
14 Real environment
15 Adaptation of application parameters
16 Identification of relevant driving scenarios
17 Evaluation of performance

What it claims is:

1. A method for automated application (10) of a driver assistance system that is configured to implement a plurality of automated driving functions, the method comprising: assigning at least one application parameter to each automated driving function (12); assigning to each application parameter a respective parameter range within which the respective application parameter can be changed without exceeding safety-critical requirements; using a control unit for identifying (16) existing driving scenarios during normal driving operations (13, 14); implementing at least one automated driving function (12) based on the driving scenario identified by the control unit; using an objective grading model for evaluating (17) a performance of the respective automated driving function that has been implemented; and adapting (15) the at least one respectively assigned application parameter as a result of an optimization (11) and on the basis of the evaluation (17) of the performance of the respectively implemented automated driving function (12).

2. The method of claim 1, wherein the respective automated driving function (12) is evaluated based on driver evaluations in addition to the evaluation (17) by the objective grading model.

3. The method of claim 1, wherein the respective evaluation (17) is evaluated internally in the vehicle.

4. The method of claim 1, wherein the respective evaluation (17) is evaluated via a cloud service and the method further includes transmitting a respective result to the driver assistance system.

5. The method of claim 4, wherein the method further includes using the cloud service fro transmitting the respective result to a manufacturer of the driver assistance system.

6. The method of claim 5, wherein a respective lower limit and a respective upper limit for settings of the respective application parameters are newly determined by the manufacturer from the transmitted results.

7. The method of claim 1, wherein all application parameters are reset to the factory setting by the driver.

8. A control unit for automated application (10) of a driver assistance system of a vehicle, the control unit comprising: a computing unit and a memory unit, the control unit being in communicative connection with the driver assistance system of the vehicle and in communicative connection with sensors and actuators of the vehicle that are controlled by the driver assistance system, the driver assistance system being configured to implement a plurality of automated driving functions, the memory having at least one application parameter assigned to each automated driving function, each application parameter being preset by a factory setting that also defines parameter ranges within which each of the application parameters can be changed in a manner consistent with safety-critical requirements, the memory unit being configured to store all data of the sensors and the actuators controlled by the driver assistance system, the control unit further using an objective grading model during a normal driving operation (13, 14) to evaluate performance of the automated driving functions (12) implemented by the driver assistance system and to adapt (15), as a result of an optimization (11), the at least one respectively assigned application parameter on the basis of the evaluation (17) of the performance of the respectively implemented automated driving function (12).

9. The control unit of claim 8, wherein the control unit additionally is configured to evaluate the respective automated driving function (12) based on driver evaluations in addition to the evaluation (17) by the objective grading model.

10. A computer program product with a computer-readable medium, on which an executable program code for automated application (10) of a driver assistance system configured to implement a plurality of automated driving function is stored, wherein, when executed on a computing unit, the program code causes the computing unit to carry out, in continued execution, the following steps:
storing all data of a plurality of sensors and actuators controlled by the driver assistance system relating to a respective automated driving function (12) implemented by the driver assistance system;
identifying (16) a relevant driving scenario;
evaluating (17) the performance of the respectively implemented automated driving function (12);
optimizing (11) at least one respective application parameter assigned to the respectively implemented automated driving function (12); and
adapting (15) the at least one respectively assigned application parameter.
